(19) United States
(12) Patent Application Publication
(10) Pub. No.: US 2005/0199644 A1
(43) Pub. Date: Sep. 15, 2005

(54) Anti-theft arrangement for packaged-product vending machines

(76) Inventors: Sergio Pensenti Barili, Bergamo (IT); Roberto Sichich, Bergamo (IT)

Correspondence Address: WENDEROTH, LIND & PONACK, L.L.P., 2033 K STREET N. W., SUITE 800, WASHINGTON, DC, 20006-1021, US

(21) Appl. No.: 10/515,437

(22) PCT Filed: Apr. 14, 2003
(86) PCT No.: PCT/EP03/03849

§ 371 Date: May 6, 2005

(30) Foreign Application Priority Data
May 27, 2002 (IT) PN2002A000036

(51) Int. Cl. G07F 11/06

(52) U.S. Cl. 221/90

(57) ABSTRACT

The present invention relates to an anti-theft arrangement for packaged-product vending machines that comprise a cabinet-like outer casing (2) containing the products to be vended, and provided with a product dispensing compartment that is constituted by a hopper (6) which is movable from a closed position into an opened one and vice-versa. The anti-theft arrangement comprises at least a strut (10) and an actuator (11, 12, 14) for moving the strut (10) from a first operating position, in which the strut (10) is adapted to co-operate with the hopper (6) to lock it in its closed position, to a second operating position, in which the strut (10) enables the hopper (6) to be movd into its opened position and the selected products to be withdrawn, and vice-versa. Both the strut (10) and the actuator (11, 12, 14) are housed within a containment casing (9) adapted to be attached inside the cabinet-like outer casing (2).

The present invention refers to an anti-theft arrangement for vending machines for packaged products, such as food products wrapped up, sealed or filled in packages, cans or bottles, which are delivered down into a dispensing compartment that is accessible to the users who are in this way able to pick up, i.e. withdraw the selected products.

Vending machiries of such a kind, usually provided with a cabinet-like outer casing closed by a glazed door, are being used since a long time now and may store products either at an ambient temperature or under refrigeration conditions; in the latter case, the vending machine is provided with a refrigerating circuit whose characteristics and construction are well-known in the art.

The dispensing or product-delivery compartment itself is generally formed by a hopper-like arrangement, that is usually situated in the lower portion of the front surface of the vending machine cabinet, through which the selected products being dropped from the shelf on which they are stored in the cabinet are collected for withdrawal; said hopper is usually provided with a swinging or similar lid for shutting off and protecting the withdrawal zone.

A major problem that arises in connection with the dispensation of these packaged products lies in the actual ability in preventing products from being unduly withdrawn through the dispensing hopper and the interior of the vending machine from being exposed to vandalisms. To this purpose, vending machines have been developed, which are provided of anti-theft arrangements that work in such a manner as to shut the passage through which the products are unloaded from the place in which they are stored into the product-delivery hopper at the same time as the user gains access into the product-delivery compartment for withdrawing the selected product.

The Italian patent application no. PN2001A000035 filed on May 8^{th}, 2001 by this same Applicant refers to a vending machine in which the product dispensing arrangement is integrated with an anti-theft mechanism. In particular the hopper is connected to both the cabinet or outer casing of the vending machine and a swinging partition via a toggle-lever mechanism in such a manner as to ensure that, when the hopper is being opened by the user for withdrawing the selected product therefrom, the swinging partition is caused to automatically displace and shut off the aperture through which the products pass from the interior of the cabinet into the dispensing hopper.

Although the anti-theft mechanism disclosed in the above-cited patent application proves substantially effective in warding off any possibility for products to be unduly withdrawn from the vending machine, it however has a limited capacity in resisting, i.e. effectively opposing possible vandalisms directed at the interior of the vending machine or preventing the hopper from being used unfittingly, as this may for instance occur when the compartment is used for throwing or placing rubbish into it. This comes from the fact that the mechanism is not capable of locking the hopper, so as to prevent it from opening, when the vending machine is not in an operating condition, in such a manner as to prevent access to the interior of the vending machine from being gained outside of the normal conditions of utilization of the machine, i.e. except of the case in which a vended product must be withdrawn upon having been duly selected and paid in advance.

Another drawback, further to the complexity of both the structure and the construction of the above mechanism deriving from the linkage system on which its operation is based, lies in the fact that the integration of the same mechanism with the vending machine implies that the latter has practically to be specially designed and constructed originally to accommodate it to such incorporation of said mechanism, since retro-fitting this mechanism on existing machines is practically impossible.

It therefore is a main object of the present invention to overcome all these drawbacks of prior-art solutions by providing an anti-theft arrangement for packaged-product vending machines, which effectively enables the product-dispensing hopper to be solely opened, and access to be gained thereinto, as a result of a product having actually been selected and duly pre-paid by a user.

Within the above-mentioned general object, a major purpose of the present invention is to provide an anti-theft arrangement which is capable of being installed without distinction both originally, i.e. when the vending machine is first manufactured, and as a retro-fit in existing vending machines in the field, without this implying the architecture of the vending machines themselves to have to undergo any substantial modification or adaptation.

Another major purpose of the present invention is to provide an anti-theft arrangement which has a structure that is so simplified as to enable the same arrangement to be manufactured in a much more convenient manner.

A further, not less important purpose of the present invention is to provide a substantially low-cost anti-theft arrangement which can be obtained through the use of readily available tools, machinery and techniques.

According to the present invention, the above-indicated aims, along with further ones that shall become apparent from the following description, are reached in an anti-theft arrangement for vending machines that incorporates the characteristics as recited in the appended claim 1.

Further features and advantages of the present invention will anyway be more readily understood from the description of a preferred, although not sole embodiment that is given below by way of non-limiting example with reference to the accompanying drawings, in which:

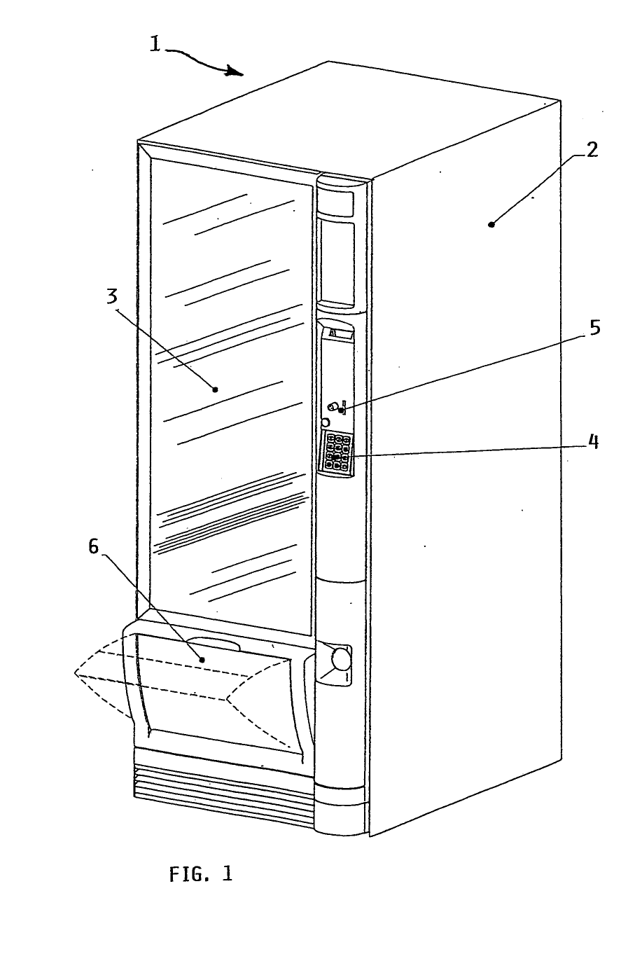

FIG. 1 is a front perspective view of a packaged-product vending machine;

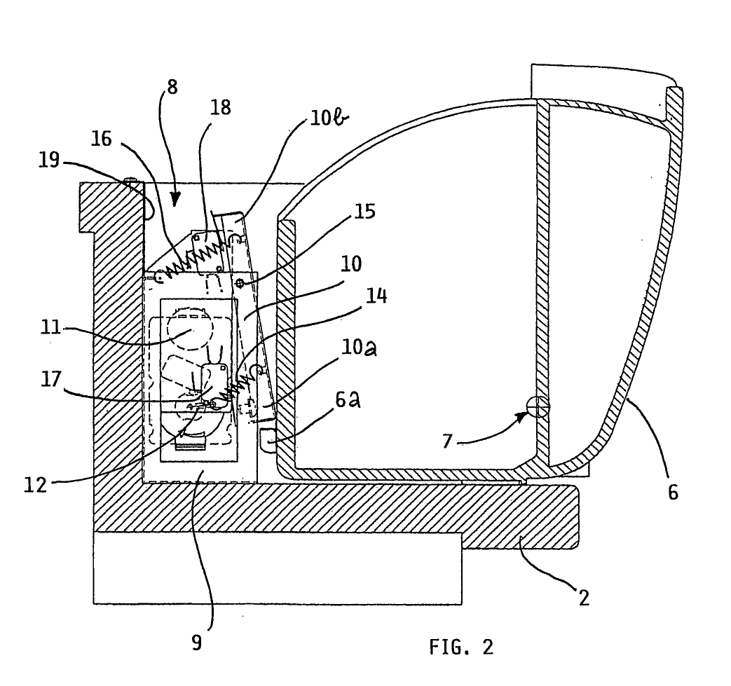

FIG. 2 is a side cross-sectional view of a detail of the vending machine shown in FIG. 1 incorporating an anti-theft arrangement according to the present invention, in a first operating position thereof;

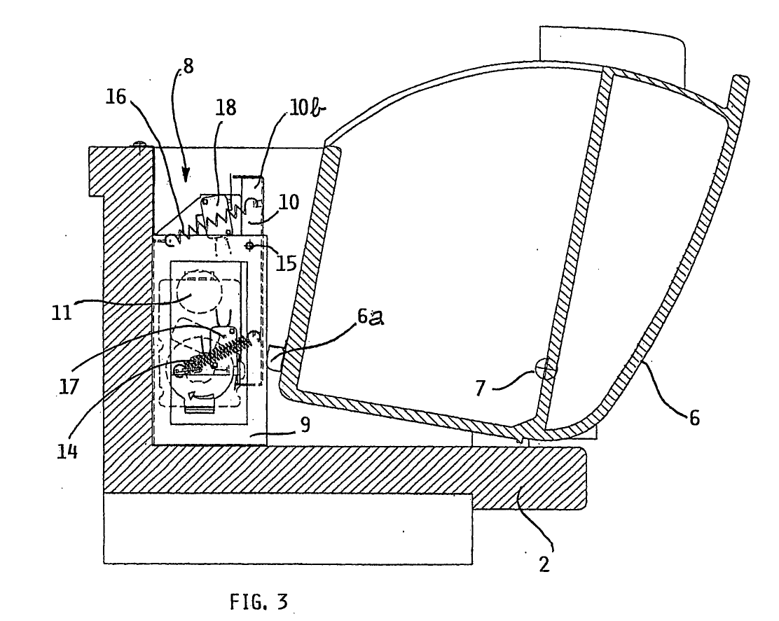

FIG. 3 is a same view as the one shown in FIG. 2 of the same anti-theft arrangement, in a second operating position thereof; and

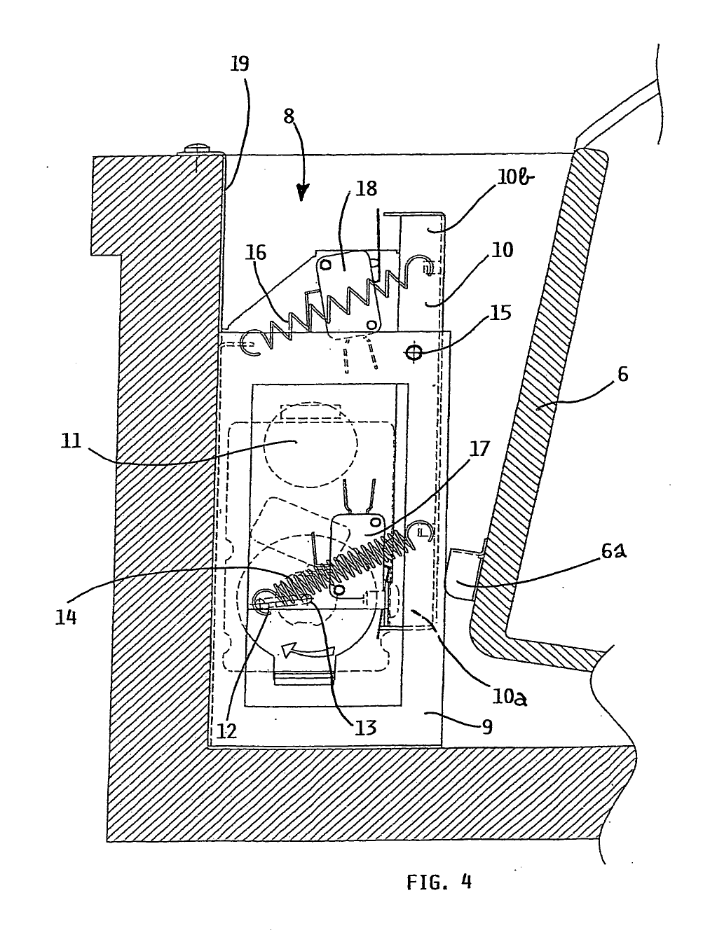

FIG. 4 is an enlarged-scale view of the same detail shown in FIG. 3.

With reference to the above-listed Figures, a packaged-product vending machine, which is generally indicated at 1 in the Figures, is substantially constituted by a cabinet-like outer casing 2, which is closed on the front side by a glazed door 3 enabling the products stored inside the vending machine, and arranged on appropriate shelves provided therewithin, to be properly viewed from the outside.

On the front wall of the vending machine, at a side of the glazed door thereof, there are arranged the various control devices of the apparatus, such as the push-buttons 4 for selecting the products to be vended, and the coin-operated or similar payment device 5. In the lower portion of the vending machine, again on the front side thereof, there is installed a hopper 6, or similar arrangement, into which the dispensed products, upon having been duly selected and paid for, are unloaded for the buyer to pick them up. This hopper 6 is adapted to normally swing about a first axis 7, which extends parallel to the resting plane of the vending machine, from a closed position, in which it lies flush with the front wall of the cabinet (see FIG. 2), to an open pick-up position, in which it on the contrary protrudes from said front wall (FIG. 3). In the lower portion of the rear surface thereof, said hopper 6 is provided with a protruding jut 6a, the function of which shall be further explained further on. This jut 6a may be either attached, i.e. applied to the hopper or be formed integrally therewith.

The anti-theft arrangement according to the present invention, which is generally indicated at 8 in the Figures, is installed inside the cabinet-like outer casing 2 of the vending machine 1, most advantageously in a zone lying behind the hopper 6, and comprises a containment casing 9 to which there is associated a strut 10 adapted to move between a first operating position, in which a first end portion 10a of the strut 10 protrudes from the casing 9 (FIG. 2) to co-operate with the jut 6a protruding from the hopper 6, and a second operating position in which the strut 10 is fully retracted into the casing 9 (FIG. 3). To this casing 9 there is further associated an actuator mechanism adapted to interact with said strut 10 so as to displace the latter from said first to said second operating position and vice-versa. This actuator mechanism includes an electric motor 11 connected, via a transmission (not shown), to a crank 12 that is adapted to rotate clockwise about the second axis 13 extending parallel to said first axis 7; a variable-length connecting rod 14, preferably in the form of an elastically deformable member such as a helical spring, interconnects said crank 12 and the strut 10 so as to transmit on to said strut 10 the motion imparted by the motor 11.

The containment casing 9 is attached to the cabinet-like outer casing 2 10 by means, for instance, of a bracket 12.

The strut 12 can be connected to the casing 9 in such a manner as to be rotatable about the third axis 15, extending parallel to said second axis 13 of the crank 12, so as to be able to swing to and from said first and said second operating position thereof. It will of course be appreciated that use can be made of a number of different methods for kinematically connecting the strut 10 to the casing 9, as far as these methods enable an end portion of the strut 10 to be brought from an extracted position, in which it co-operates with the jut 6a, to a retracted position in which it no longer co-operates with said jut 6a. For example, a translational displacement with respect to the casing 9 towards the hopper 6 enables the same result to be obtained.

In an advantageous manner, an elastic member 16, such as a helical spring, interconnects the second end portion 10b of the strut 10 to the casing 9; this elastic member 16 is used to bias the strut 10 into moving back from the retracted position to the extracted one.

The anti-theft arrangement is further provided with a pair of sensors 17 and 18 that are adapted to detect the position of the strut 10. These sensors may be constituted by micro-switches 17, 18 arranged in the proximity of the first end portion 10a and the second end portion 10b of the strut 10, respectively, and capable of selectively co-operating with such end portions.

The operation of the above described arrangement is as follows: starting from the condition in which the vending machine is in a stand-by mode, waiting for a product to be selected by a user, the strut 10 is in its first operating position, in which the end portion 10a thereof is extracted to co-operate with the jut 6a (FIG. 2) so as to oppose any attempt that may be made at opening the hopper 6 by causing it to rotate about the first axis 7 and, therefore, to prevent any undue access from being gained through the same hopper into the interior of the outer casing 2 of the machine by vandals or other ill-intentioned people. In this position, the micro-switch 18 is closed due to the action of the pressure exerted by the second end portion 10b of the strut 10 thereupon, thereby indicating the “blocked” position of the anti-theft arrangement to the central control system of the vending machine.

The information relating to the coins having been inserted and the desired product having been selected by a user is detected by the central control system of the machine and sent to the motor 11, which then drives the crank 12 to cause it to perform a 180°-rotation. Via the variable-length connecting rod 14, such a motion causes the strut 10 to retract, thereby displacing it from said first operating position to said second operating position thereof (FIG. 3). In this manner, the jut 6a is no longer locked, thereby enabling the user to open the hopper 6 to withdraw the selected product. In this position, the contact with the micro-switch 17 is closed by the first end portion 10a of the strut 10, thereby indicating the “released” position of the anti-theft arrangement to the central control system of the vending machine. At the end of a pre-determined programmable period of time, during which the anti-theft arrangement remains in this “released” condition thereof, the motor 11 drives the crank 12 through a further 180°-rotation, which, via the above-mentioned variable-length connecting rod assisted by said second elastic biasing member 16, pushes the strut 10 again into the extracted position thereof so as to block the jut 6a and restore the “locked” condition of the anti-theft arrangement.

From the description given above, the anti-theft arrangement according to the present invention can therefore be fully appreciate to actually reach all of the afore indicated aims and advantages. In fact, the ability of the anti-theft arrangement to effectively oppose vandalisms of any kind and preventing the compartment of the dispensing hopper from being used unfittingly is considerably improved, thanks not only to the arrangement itself being effective in enabling the hopper to be solely opened as a result of the actual product selection and pre-payment commands entered by a user, but also to the possibility for the time during which the hopper is allowed to remain open to be programmed so as to be strictly limited to the actual time needed for the vended products to be picked up.

In addition, the compactness of the arrangement and the fact that all component parts thereof are contained within the casing 9 enables the operability of the same arrangement to be ensured in all cases, irrespective of the actual characteristics of the vending machine in which it is installed. As a result, this makes it possible for anti-theft arrangements to be made in a modular form for application as retro-fits to existing vending machines in the field, the addition to the hopper of a protruding jut capable of co-operating with the strut 10 being the sole requirement that needs being complied with in this case, or to be provided directly for installation in the vending machines as these are originally manufactured at the factory.

Finally, the simplified and extremely compact structure of the anti-theft arrangement according to the present invention makes it possible for it to be constructed in a much more convenient, easy manner.

It shall be appreciated that the above described anti-theft arrangement may be the subject of a number of different applications, modifications and variants without departing from the scope of the present invention. Even the materials used to implement the arrangement of the present invention, as well as the shape, form and size of the individual component parts thereof may be from case to case selected to most appropriately comply with particular needs and requirements without departing from the scope of the present invention.

1-9. (canceled)

10. Anti-theft arrangement for a packaged-product vending machine that comprises a cabinet-like outer casing containing the products to be vended, and is provided with a product dispensing compartment constituted by a hopper mounted on the front wall of said cabinet-like outer casing, said hopper being movable between a closed position, in which it lies flush with said front wall, and an open pick-up position, in which it protrudes from said front wall, characterized in that, said anti-theft arrangement comprises at least a strut and an actuator for moving said strut between an extracted position and a retracted position, wherein in said extracted position said strut is adapted to co-operate with said hopper to lock it in said closed position when the vending machine is in a stand-by mode, and in said retracted position said strut enables said hopper to be moved into said opened position when the vending machine is vending a selected product such that the selected product can be withdrawn, said strut and said actuator being housed within a containment casing adapted to be attached inside said cabinet-like outer casing.

11. Anti-theft arrangement according to claim 10, wherein said hopper is provided with at least a jut protruding from the surface of said hopper facing said strut, said jut being adapted to co-operate with said strut in said extracted position to lock said hopper in said closed position.

12. Anti-theft arrangement according to claim 11, wherein in said extracted position a first end portion of said strut protrudes from said containment casing to co-operate with said jut, and in said retracted position said first end portion is retracted into said containment casing.

13. Anti-theft arrangement according to claim 10, wherein said actuator comprises an electric motor operationally connected to a crank that is adapted to rotate about a second axis, said crank being interconnected with said strut via a variable-length connecting rod.

14. Anti-theft arrangement according to claim 10, wherein said arrangement further comprises a pair of sensors adapted to respectively detect said extracted position and said retracted position of said strut.

15. Anti-theft arrangement according to claim 10, wherein said arrangement further comprises elastic return means to bias said strut into moving back from said retracted position to said extracted position, said elastic means interconnecting said strut with said containment casing.

16. Anti-theft arrangement according to claim 10, wherein said strut is rotatably connected to said containment casing so as to be able to swing between said extracted and retracted positions about a third axis extending parallel to said second axis.

17. Packaged-product vending machine comprising an anti-theft arrangement according to claim 10.
